(19) United States
(12) Patent Application Publication
(10) Pub. No.: US 2004/0187653 A1
(43) Pub. Date: Sep. 30, 2004

(54) Rotatable seat for cutting tool insert

(76) Inventor: Terry Chunn, Spring, TX (US)

Correspondence Address: STOEL RIVES LLP, 900 SW FIFTH AVENUE, SUITE 2600, PORTLAND, OR, 97204, US

(21) Appl. No.: 10/401,425

(22) Filed: Mar. 28, 2003

(51) Int. Cl. B23B 3/00

(52) U.S. Cl. 82/1.11

(57) ABSTRACT

A rotatable seat for an insert of a machine tool that has a clamp for holding the insert securely in place during the machining operations. The seat has a substantially cylindrical body that includes a longitudinally extending throughbore, and a first end and a second end. The first end has a v-shaped trough that is sized to receive the v-shaped back end of an indexable (or other type) of insert. The second end of the rotatable seat is sized and shaped for seating flush against a back end of the clamp of the cutting tool. A press fit, or other fastener, extends through the throughbore of the seat body into a bore in the back end of the clamp and the seat is able to rotate about the fastener. The seat is positioned at and angular orientation and the insert is then fitted in the v-shaped trough in the seat in a corresponding angular orientation. These two components as assembled together and held in place by tightening the clamp fastener. By periodically loosening the clamp and rotating the insert, as the cutting edge is worn, fresh cutting edge is exposed. The rotation thereby prolongs the useful life of the insert.

### COPYRIGHT NOTICE

©2001 Wyman—Gordon Forgings, Texas. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

### TECHNICAL FIELD

This invention relates to cutting machine tools, more particularly to a rotatable seat for use in conjunction with inserts, that permits rotation of the insert to expose fresh cutting edges, as cutting edges are subject to wear.

### BACKGROUND OF THE INVENTION

Many machine shops, and other industrial facilities, utilize machines that cut or shape metal, wood, and other materials. Among these machines, for example, are lathes, that are commonly used to shape materials such as bar stock. In general, in these applications a metal bar is clamped longitudinally in a chuck of a lathe, and is rotated at a pre-determined and controlled speed. A cutting tool, known as an insert, is mounted into a clamp, that is affixed to the lathe or other cutting and shaping machine. The cutting tool can move laterally, i.e., it can be moved forward toward the axis of the rotating bar stock, or backward away from the axis; and can also translate i.e. move longitudinally along the length of the bar stock. By moving the clamp forward, until the cutting edge of the insert contacts the bar stock, the outer surface of the bar stock can be cut. The combination of lateral movement and translation permits shaping or cutting the bar stock, as desired.

Lathes are well-known in the art, and can be used to manufacture complex shapes, especially when subject to computer control of the movement of the clamp (and the cutting edge of the insert) laterally and longitudinally relative to the rotating stock held in the chuck. However, particularly in the case when metals and hard materials are being shaped, the cutting edge of the insert is subject to significant wear. This mechanical wear can be reduced, through the use of hardened inserts, using ceramics and/or tungsten carbide. Nonetheless, depending upon the relative hardness of the stock being shaped and the insert material, some degree of wear is inevitable even if coolant is applied and other precautions are taken. Once the edge has been worn to a significant degree, either the rate of cutting must be reduced, or the surface quality of the stock material will be adversely affected. Accordingly, at some point, it is standard practice to replace the insert, and to discard the old one.

The cost of replacing worn inserts is a significant cost for any machine shop, and this cost must be factored into the cost of production on the machine using the insert. Accordingly, there is a significant interest in reducing the number of inserts used, while maintaining quality control and efficiency, in order to reduce operating costs.

### SUMMARY OF THE INVENTION

The invention provides a device, and method of using the device, that extends the useful life of an insert for a cutting tool.

In one embodiment, the invention provides a rotatable seat for an insert of a cutting tool that has a clamp for holding the insert securely in place during the machining operations. The seat has a substantially cylindrical body that includes a longitudinally extending throughbore, and a first end and a second end. The first end has a v-shaped trough that is sized to receive the v-shaped back end of an indexable or other type of insert. The second end of the rotatable seat is sized and shaped for seating against a back end of the clamp of the cutting tool. A bolt, or other fastener, extends through the throughbore of the seat body and is press fit into a bore in the back end of the clamp, when the rotatable seat is aligned in the clamp. Tightening this bolt fixes the seat in place in a desired angular orientation. The insert resides in the v-shaped trough in the seat in a corresponding angular orientation and is held in place by tightening the clamp fastener.

In another embodiment, the invention provides a method of extending the useful life of a cutting insert of a cutting tool and a method of operating a machine tool. The method includes inserting a rotatable seat into the clamp of a cutting tool, between a back end of the insert that has a v-shaped protrusion and the back end of the clamp. The seat includes a substantially cylindrical body portion that has a longitudinally extending axial throughbore. At a first end of the rotatable seat is a v-shaped trough for receiving the v-shaped protrusion of the insert. The second end of the rotatable seat is sized and shaped for interfacing with the back end of the clamp of the cutting tool. Further, the method includes inserting a fastener into the throughbore, and press fitting the fastener into a bore in the back end of the clamp, when the seat is aligned in the clamp, to hold the seat in place. The method of use includes closing the clamp of the tool to fix the insert and the rotatable seat in place, with the insert in a cutting position. After a period of cutting, mechanical wear will degrade the cutting surface of the insert, and the method includes loosening the clamp, and rotating the seat and the insert in concert, to expose another edge of the insert for cutting.

Additional aspects and advantages of this invention will be apparent from the following detailed description of preferred embodiments, which proceeds with reference to the accompanying drawings.

### BRIEF DESCRIPTION OF THE DRAWINGS

FIG. 1 is a perspective view of an embodiment of the invention;

FIG. 2 is a side view, in partial cross section, showing details of an embodiment of the invention; and

FIG. 3 is a perspective view of an embodiment of the invention, showing in an exploded schematic the relevant parts.

### DETAILED DESCRIPTION OF PREFERRED EMBODIMENTS

Cutting inserts, commonly known as “inserts” are used in a variety of machine tools, particularly in turning and milling operations. In an increasing number of cutting applications, ceramic inserts are used. In many cases, these are “indexable ceramic inserts”, that have a back end that is v-shaped, with an apex of the “v” extending outward. The v-shape is designed to cooperate with a corresponding v-shaped trough in the back end of a cutting tool clamp, to permit secure clamping of the insert into the clamp, to prevent angular movement of the insert in the clamp while it is in use.

Although ceramic inserts are hard, they are not immune to mechanical wear. Ceramic inserts show flaking along the cutting edge, with small pieces around the cutting edge are removed. While this exposes potentially new cutting edges, mechanical wear nonetheless takes place. Ultimately, the insert must be rotated through 180 degrees, to turn the insert “upside down” so that cutting then commences on the opposite edge of the insert. Once the second edge is worn out, the insert must be discarded.

It has now been recognized that the useful life of an insert can be increased, regardless of the material of construction or cutting edge material, if it were possible to rotate the insert through less than 180 degrees, such as through a smaller number of degrees, for example 10 degrees, to thereby expose a fresh cutting surface periodically. However, current indexable insert design with the v-shaped back end, as discussed above, restricts rotation to only 180 degrees. The invention, in one of its embodiments, solves this problem by providing a 360 degree rotatable seat for an indexable insert. Thus, the seat and insert rotate in concert by a selected number of degrees periodically as a cutting edge wears down. For example, rotation by 5, 10, 15, 20 or 30 degrees, until all potential cutting edges are worn. Aspects of the invention are best understood with reference to the appended figures.

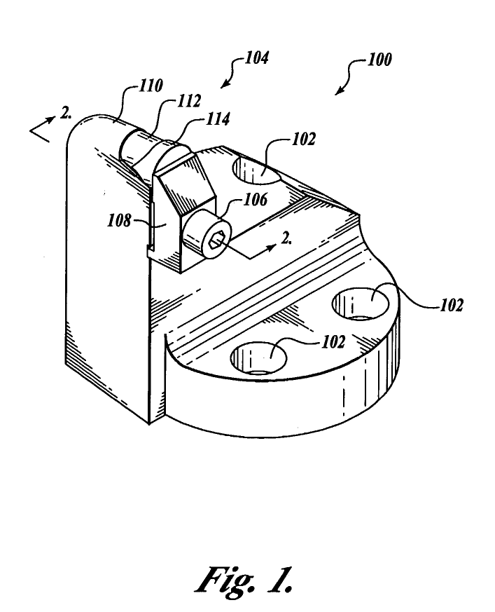

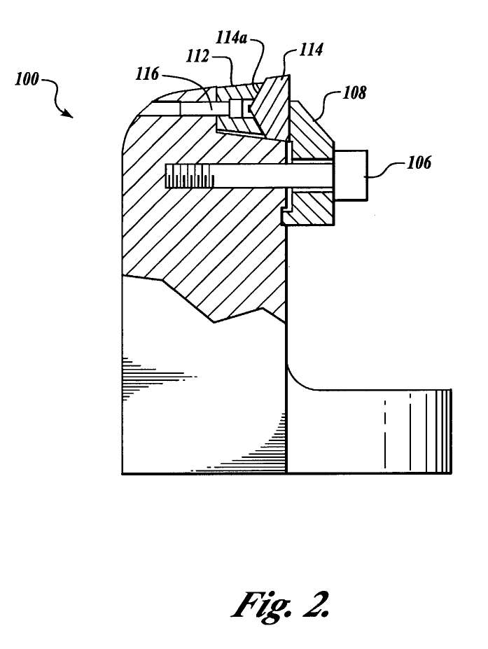

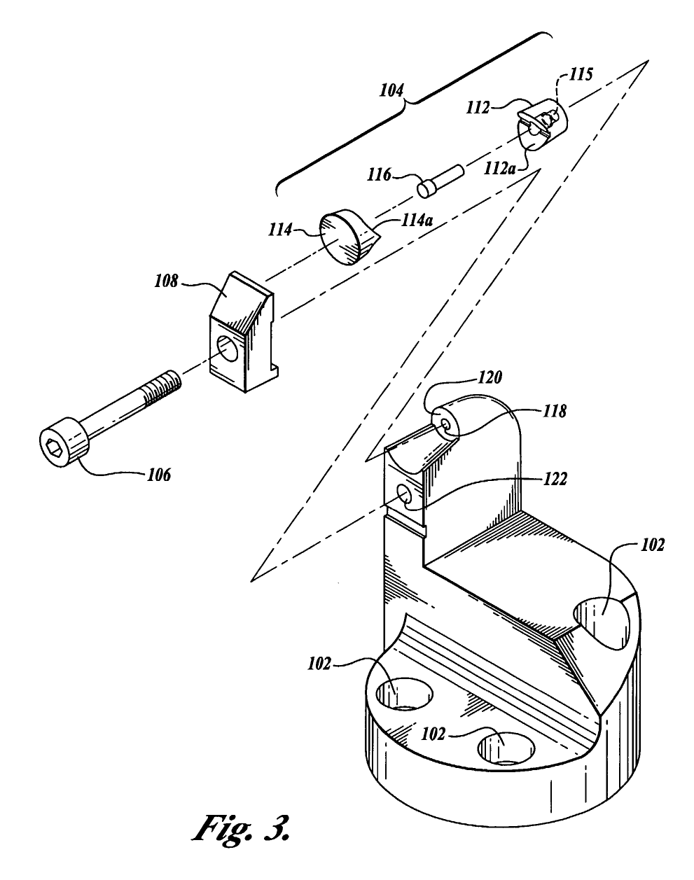

An embodiment of the invention is shown in FIGS. 1, 2 and 3. Referring to these figures, a clamp 100 of a cutting tool has a series of throughbores 102, for affixing the clamp to the machine tool body. As can be seen, particularly in FIG. 3, the assembly 104 that is clamped between clamp ends 108 and 120 includes at least three parts: a cutting insert 114, a rotatable seat 112, and a bolt 116 that extends through the rotatable seat for press fitting into a bore 118 in the back end of the clamp 120. The clamp is closed by rotating bolt 106 that extends through clamp front end 108 into threaded bore 122. When the clamp is closed, the assembly fits together, as shown in FIG. 1 and FIG. 2.

As can be seen more clearly from FIGS. 2 and 3, the insert 114, has a substantially cylindrical body with taper from the front to the back end 114a of a few degrees, so that it is slightly conical. The insert has a flat front end that cooperates with the flat inside surface of the front end of the clamp 108, and a rear end 114a that has a protruding v-shape. This is a characteristic of an indexable insert, and permits the insert to be rotated through 180 degrees, after it has been used in the first position to the point where the cutting edge has been worn.

In accordance with the invention, there is now provided a substantially cylindrical rotatable seat 112, that has a front end 112a provided with a v-shaped trough sized and shaped to receive the back end 114a of the insert, in a snug fit. Thus, when 114 is seated within 112, there is little or no radial movement between these two components, i.e., the fit is “snug”. The seat preferably has a radius approximating that of the insert to which it is mated, and length sufficient to permit ease of closing of the clamp 100.

Seat 112 is equipped with a throughbore 115, that is sized to receive a fastener, such as press fit bolt 116. In use, bolt 116 extends through the throughbore 115 and is press fit into the bore 118 in the back of the clamp 120. As a consequence, seat 112 can rotate relatively freely around bolt 116, until bolt 116 is pressed tight into bore 118, when seat 112 is effectively held in place in angular orientation. This also fixes the angular position of the v-shaped trough 112a. Since the back end 114a of insert 114 cooperates with the front v-shaped trough 112a of seat 112, the angular orientation of the insert 114 matches that of seat 112. Accordingly rotation of the seat through a certain preselected number of degrees, also rotates the insert in concert. Further, when the clamp is closed, by driving bolt 106 through front end 108 of the clamp into bore 122, the entire assembly 104 is prevented from lateral movement, and is held immobile so that the insert is in a cutting position.

The clamp 100, as discussed above, may be mounted to a platform of a cutting machine tool, such as a lathe, in which it can translate (move longitudinally along the length of the lathe) and move laterally (in directions inboard and outboard of the lathe). Accordingly, the use of the rotatable insert of the invention does not affect the operation of cutting tools, except that the rotatable seat permits better utilization of the potential cutting edges of an insert, by allowing a virtually infinite range of rotation of the insert, not heretofore possible. As explained above, prior art inserts were only rotatable by 180 degrees, thereby only providing two potential cutting edges. The provision of potentially multiple cutting edges through greater freedom in selecting degrees of rotation significantly increases the potential life of the cutting insert, and thereby reduces operating costs.

In other embodiments, the invention provides a method of extending the useful life of a cutting insert of a cutting tool and a method of operating a machine tool. The methods include inserting a rotatable seat into the clamp of the machine tool, between a back end of the insert (that has a v-shaped protrusion) and the back end of the clamp. The seat, as discussed above, includes a substantially cylindrical body portion that has a longitudinally extending axial throughbore. At a first end of the rotatable seat is a v-shaped trough for receiving the apex of the v-shaped protrusion of the insert in a snug fit. The second end of the rotatable seat is sized and shaped for interfacing with the back end of the clamp of the cutting tool, and preferably is flat to mate with a flat inside surface of the clamp back end. Further, the method includes inserting a press fit bolt into the throughbore, and pressing the bolt into a bore in the back end of the clamp, when the seat is aligned in the clamp, to hold the seat in place. The method of use includes closing the clamp of the tool to fix the insert and the rotatable seat in place, with the insert in a cutting position. After a period of cutting, mechanical wear will degrade the cutting surface of the insert, and the method includes loosening the clamp, and rotating the seat and the insert in concert, to expose another edge of the insert for cutting. Then pressing home the bolt 116, and closing the clamp 100.

It will be obvious to those having skill in the art that many changes may be made to the details of the above-described embodiments without departing from the underlying principles of the invention. The scope of the present invention should, therefore, be determined only by the following claims.

1. A rotatable seat for an insert of a cutting tool, the seat comprising:
a seat body comprising: a longitudinally extending throughbore, a first end and second end; the first end comprising a V-shaped trough sized for registration with a V-shaped end of a tool insert, the second end sized and shaped for interfacing with a back end of a clamp of the cutting tool.

2. The seat of claim 1, wherein the seat is substantially cylindrical.

3. The seat Of claim 2, wherein the seat diameter approximates a diameter of an insert co operating with the seat.

4. A method of using a machine tool that comprises an insert, the method comprising:
inserting into a clamp of a cutting tool, between a back end of the insert and a back end of a clamp, a rotatable seat comprising a body, the body of the seat comprising: a longitudinally extending throughbore, a first end and a second end, the first end comprising a V-shaped trough sized for close registration with the back end of the insert, and a second end sized and shaped for interfacing with the back end of the clamp of the cutting tool;
inserting a bolt into the throughbore and extending the bolt into a bore in the back end of the clamp, when the seat is aligned in the clamp;
closing the clamp of the tool to fix the insert and rotatable seat in place, with the insert in a cutting position; and
loosening the clamp and rotating the seat after cutting has worn a cutting edge of the insert, to expose another edge of the insert for cutting.

5. The method of claim 4, wherein the rotating comprises rotating by less than about 180 degrees.

6. The method of claim 4, wherein the rotating comprises rotating by at least about 5 degrees.

7. The method of claim 4, wherein the rotating comprises rotating by at most about 30 degrees.

8. A product produced by the method of claim 4.
